(19) United States
(12) Patent Application Publication
(10) Pub. No.: US 2015/0003185 A1
(43) Pub. Date: Jan. 1, 2015

(54) MOBILE FRACKING SLURRY MIXING DEVICE

(71) Applicant: Ultra Blend Solutions, LLC, Shreveport, LA (US)

(72) Inventor: Jeremy Woodle, Shreveport, LA (US)

(21) Appl. No.: 14/314,545

(22) Filed: Jun. 25, 2014

Related U.S. Application Data
(60) Provisional application No. 61/839,733, filed on Jun. 26, 2013.

(51) Int. Cl. B01F 13/00

(52) U.S. Cl. CPC B01F 13/0018
USPC 366/136

(57) ABSTRACT

A mobile and transportable apparatus which can move and/or be moved to specific hydraulic fracking sites, and at such locations, mix together fluid and solid material component parts of a fracking slurry to form an optimal fracking slurry, maintain a fracking slurry in optimal condition for use, and deliver an optimal fracking slurry to appropriate receiving apparatus at a hydraulic fracking site.

### CROSS-REFERENCES TO RELATED MATERIALS

The present application claims the benefit of priority to U.S. provisional patent application 61/839,733, filed on Jun. 26, 2013, which is hereby incorporated by reference.

### FIELD OF THE INVENTION

The present invention generally relates to the field of hydraulic fracking of shale for oil and gas extraction. More specifically, many embodiments are directed to a mobile platform for mixing together fluids and other materials to form, maintain, and/or deliver a slurry for use in the hydraulic fracking of shale.

### BACKGROUND OF THE INVENTION

Hydraulic fracking (also referred to as hydraulic fracturing, hydrofracking, tracing, or fracking) generally refers to the induction of fractures in various subterranean rock layers by introducing a pressurized liquid into the rock or other subterranean structures. In the oil and gas industry, fracking is often conducted with a slurry of water and/or other fluid mixed with sand and/or other chemicals which is injected at high pressure into natural or man-made faults in rock formations, which subsequently triggers the release of petroleum, natural gases (e.g. shale gas, tight gas, coal seam gas, etc.), or other substances for extraction.

A traditional problem in the oil and gas industry is maintain the quality of a fracking slurry from the time of its production until its use. The additives mixed with water to form the fracking slurry can at least partially fall out of suspension during, and due to, transport of the fracking slurry from the location of slurry production to the site of slurry use (i.e. a well into which the fracking slurry is injected). Thus, traditionally produced fracking slurry can have less than optimal performance in triggering the release of the substances desired for extraction. This problem drives up the cost of oil and gas extraction and production, due at least to the need for more fracking slurry to sufficiently trigger the release of the substances desired for extraction, and the time required for transporting fracking slurry from the location of slurry production to the site of slurry use.

In view of the above, there remains a need to efficiently provide fracking slurry at a site of fracking slurry use, white also maintaining the fracking slurry at a certain or optimal level of quality and efficacy, without the disadvantages noted above and known in the industrial field.

### SUMMARY OF THE INVENTION

Many embodiments are directed to mobile fracking slurry mixing device having a transportable framework which includes a primary mixing section, a transfer conduit, a supplementary mixing section, and an apparatus outlet, where the primary mixing section includes a solid material hopper open to and in communication with a primary mixing conduit, such that solid material held in the solid material hopper can be drawn into the primary mixing conduit, a primary mixing tank having a concave bottom surface, in fluid communication with the primary mixing conduit, a primary mixing inlet in fluid communication with the primary mixing tank, and a primary mixing pump in fluid communication with the primary mixing inlet, the primary mixing tank, and the primary mixing conduit which is adapted to mix solid material from the solid material hopper with fluid to form a slurry and circulate the slurry therebetween, and where the transfer conduit is in fluid communication with the supplementary mixing section, and adapted to transfer slurry from the primary mixing section to the supplementary mixing section, and further where the supplementary mixing section includes a supplementary mixing tank having a concave bottom surface, in fluid communication with a supplementary mixing outlet, a supplementary mixing pump in fluid communication with the supplementary mixing outlet, and a supplementary mixing inlet in fluid communication with the supplementary mixing pump and supplementary mixing tank, where the supplementary mixing pump is adapted to circulate the slurry therebetween; and the apparatus outlet is in fluid communication with the supplementary mixing tank and adapted to transport slurry out of the supplementary mixing section.

In embodiments, the transportable framework of mobile mixing apparatus can be mounted on a flatbed truck trailer or other mobile platform. In further embodiments, the primary mixing section of the mobile mixing apparatus can also include a sample port. In alternative embodiments, the primary mixing pump of the mobile mixing apparatus is adapted to mix solid material with fluid by use of shearing forces. In yet further embodiments, the primary mixing inlet of the mobile mixing apparatus is located proximate to the bottom of the concave bottom surface of the primary mixing tank. In alternative embodiments, the primary mixing tank of the mobile mixing apparatus further includes vertically mounted primary mixing agitators. In other embodiments, the supplementary mixing tank of the mobile mixing apparatus also further includes vertically mounted supplementary mixing agitators. In some embodiments, the supplementary mixing tank of the mobile mixing apparatus is configured to direct slurry toward the supplementary mixing outlet. In further alternative embodiments, the supplementary mixing inlet is configured to generate shear forces as it transports slurry into the supplementary mixing tank.

Many embodiments are directed to a method of use of a mobile fracking slurry mixing device including a transportable framework having a primary mixing section and a supplementary mixing section, where the primary mixing section is configured to mix a solid material with a fluid to generate a slurry where the solid material is in suspension in the fluid, and can convey the slurry to the supplementary mixing section, and where the supplementary mixing section is configured to maintain the slurry such that the solid material remains in suspension in the fluid, and can store the slurry until required for use, and can further deliver the slurry to a location for use.

Many embodiments are directed to a method of producing and using a fracking slurry with a mobile fracking slurry mixing device which includes holding a solid material in a solid material hopper, drawing solid material from the solid material hopper into a primary mixing conduit and combining the solid material with fluid in a primary mixing tank to form a slurry, circulating the slurry with a primary mixing pump between the primary mixing conduit, the primary mixing tank, a primary mixing inlet, and the primary mixing pump, conveying the slurry through a transfer valve to a transfer conduit, conveying the slurry from the transfer conduit into a supplementary mixing tank, circulating the slurry with a supplementary mixing pump between the supplementary mixing tank, a supplementary mixing outlet, the supplementary mixing pump and a supplementary mixing inlet, maintaining the slurry in suspension in the supplementary mixing tank, and delivering the slurry from the supplementary mixing tank through an apparatus outlet out of the mobile mixing apparatus.

### BRIEF DESCRIPTION OF THE DRAWINGS

Illustrative aspects of the present disclosure are described in detail below with reference to the following drawing figures.

FIG. 1 is a schematic representation of elements of the mobile fracking shiny mixing device according to many embodiments.

FIG. 1A is a cross-sectional schematic representation of a front end of the transportable frame of the mobile fracking slurry mixing device as illustrated in FIG. 1.

FIG. 1B is a cross-sectional schematic representation of the primary mixing section of the mobile fracking slurry mixing device as illustrated in FIG. 1.

FIG. 1C is a cross-sectional schematic representation of the supplementary mixing section of the mobile fracking slurry mixing device as illustrated in FIG. 1.

FIG. 2 is a system diagram representing the mobile fracking slurry mixing system, according to some embodiments.

### DETAILED DESCRIPTION OF THE INVENTION

Throughout this description for the purposes of explanation, numerous specific details are set forth in order to provide a thorough understanding of the many embodiments disclosed herein. It will be apparent, however, to one skilled in the art that the many embodiments may be practiced without some of these specific details. In other instances, well-known structures and devices are shown in diagram or schematic form to avoid obscuring the underlying principles of the described embodiments.

Hydraulic fracking operations and applications in the oil and gas industry often seek to extract petroleum, natural gases, or other substances from shale formations, particularly oil shale. Generally, shale is a fine-grained, elastic sedimentary rock composed of mud that is a mix of flakes of clay minerals and tiny fragments (silt-sized particles) of other minerals, especially quartz and calcite. The ratio of clay to other minerals is variable. Shale is characterized by breaks or fractures along thin laminae or parallel layering or bedding less than one centimeter in thickness, which can be referred to as the fissility of the shale. Some hydraulic fractures in rock and shale form naturally, as seen in veins or dikes, and can create conduits along which gas and petroleum from source rocks or shale can migrate to reservoir rocks or shale. The permeability and porosity characteristics of shale reflect its ability to hold and transmit fluids such as water, oil, and/or natural gas. Particularly, shale has a small particle size such that its interstitial spaces are very small, which results in oil, natural gas and water have difficulty moving through the shale. Shale can therefore serve as a cap rock for oil, a natural gas trap, and can block or limit the flow of underground water.

Oil shale can commonly refer to rock formations that contain significant amounts of organic material in the form of kerogen, where up to one-third of the rock can be solid kerogen liquid and gaseous hydrocarbons can be extracted from oil shale, which can at least in part have regions including kerogen, but the rock must be heated and/or treated with solvents. Oil shale meets the more general definition of shale in that it is a laminated rock consisting of at least 67% clay minerals; however, oil shale sometimes contains enough organic material and carbonate minerals that clay minerals account for less than 67% of the rock. Although the interstitial spaces iii shale are small, the interstitial space can constitute a significant volume of the rock, which allows shale to hold significant amounts of water, gas, and/or oil, but not be able to effectively transmit them because of the low permeability of shale. Further, some of the clay minerals that occur in shale have the ability to absorb or adsorb significant amounts of petroleum, natural gas, ions, and/or other substances, further reducing the mobility of gases and fluids through the shale. Horizontal drilling and hydraulic fracturing can create artificial porosity and permeability within shale, and when fracking slurry is injected at a high pressure into fractured shale, petroleum, natural gas, or other substances can be physically and/or chemically forced out of the shale and collected.

A fracking slurry can be a mixture of water, oil, proppants, surfactants, and/or chemical additives, where the chemical additives are chosen to chemically trigger the shale to selectively release petroleum, natural gases, ions, and/or other substances. Chemical additives for fracking slurry can include, but are not limited to, acids, sodium chloride, polyacrylamide, ethylene glycol, borate sales, sodium carbonate, potassium carbonate, glutaraldehyde, guar gum, citric acid, isopropanol, and/or combinations thereof. Sand is often used as a proppant in fracking slurry, which can be a silica sand, a resin-coated sand, or a ceramic sand, but other powders, fine particulate matter, and/or combinations thereof can also be used as proppants, depending on the type of permeability or grain strength needed. Surfactants in a fracking slurry can operate to lower the surface tension of the slurry, the interfacial tension between liquids components of the slurry, or tension between liquid and solid components of the slurry. Surfactants in the slurry may further act as detergents, wetting agents, emulsifiers, foaming agents, and dispersants. Additionally, gels, foams, and compressed gases, including nitrogen, carbon dioxide and air can be injected along with, and/or as a component of, a fracking slurry.

As noted, a traditional problem in the oil and gas industry is maintain the quality of a fracking slurry from the time of its production, through transport to a site of its use. The additives mixed with fluid to form the fracking slurry can at least partially fall out of suspension during, and due to, transport of the fracking slurry from the location of slurry production to the a well into which the fracking slurry is injected. Conventionally, solid materials such as proppants, surfactants, and/or chemical additives are simply added at once, in bulk, to a fluid and then mechanically mixed in order to form a fracking slurry. The mechanical mixing can be performed by mechanical paddles run of of hydraulic motors, independent of or in combination with inline centrifugal pumps. Subsequently, the slurry is put into an industry standard frac tank where the solid materials can, and often do, fall out of suspension. Most consumers of fracking slurry are forced to deal with the problem of receiving suboptimal fracking slurry at the site of the slurry use.

Embodiments of the invention are directed to a mobile platform, i.e. an apparatus that can be moved from one location to another, which can mix together the materials required to form a fracking slurry, where the apparatus can further maintain the quality and characteristics of the fracking slurry, and can deliver that fracking slurry at a hydraulic fracking site. In embodiments, the mobile platform can be a flatbed trailer truck, a crane, a commercial winch truck, or other mobile platforms of similar scale and capability.

Many embodiments include a primary mixing section and a supplementary mixing section. The primary mixing section includes at least a primary mixing tank, a solid material hopper that provides solid components of a fracking slurry to the primary mixing tank, a primary mixing pump, and piping configured to circulate fluid and/or slurry between the primary mixing tank and the primary mixing pump. In embodiments, the fluid to which solid material is added can be a surfactant package, which can be a combination of a mineral oil with surfactants; which when mixed with solid material from the solid material hopper, form a fracking slurry. In embodiments, the primary mixing pump can be a centrifugal pump. In embodiments, the primary mixing tank can hold from 5000 to 7000 gallons of fluid and/or slurry, while the solid material hopper can hold up to 7000 pounds of solid material, which is often in the form of a powder or granulated clay. The piping is further configured to provide fluid communication from the primary mixing section to the supplementary mixing section, through a system including a transfer valve and transfer conduit.

The supplementary mixing section includes at least a supplementary mixing tank, a supplementary mixing pump, and piping configured to circulate a slurry between the supplementary mixing tank and the supplementary mixing pump, maintaining the slurry in suspension and also maintaining other functional characteristics of the slurry. In embodiments, the supplementary mixing pump can be a centrifugal pump. The supplementary mixing tank can hold from 10,000 to 15,000 gallons of slurry. The primary mixing tank and supplementary mixing tank can both have a rectangular shape toward the top of the tanks, while the bottom surface of each tank can be configured and shaped to maintain a suspension of a fracking slurry. The primary and supplementary mixing tanks can be designed and configured to maximize the volume of each tank within the framework of the mobile platform. The supplementary mixing section further includes an interface for delivering fracking slurry to an external receiver, such as injection apparatus for delivering fracking slurry into a hydraulic fracking well.

It is to be noted that while the many embodiments disclosed herein are generally directed to a mobile fracking slurry mixing device and method of use for oil and gas industry applications, the mobile mixing device can be used in any industry or field of use where it would be advantageous to transport a mixing apparatus for a certain volume of slurry, fluid suspension, and/or solution production to specific operational locations. The embodiments disclosed herein provide for the ability to locally produce any desired slurry, fluid suspension, and/or solution in order to mitigate against problems stemming from transporting such a slurry, fluid suspension, and/or solution from a separate, off-site, production location or plant.

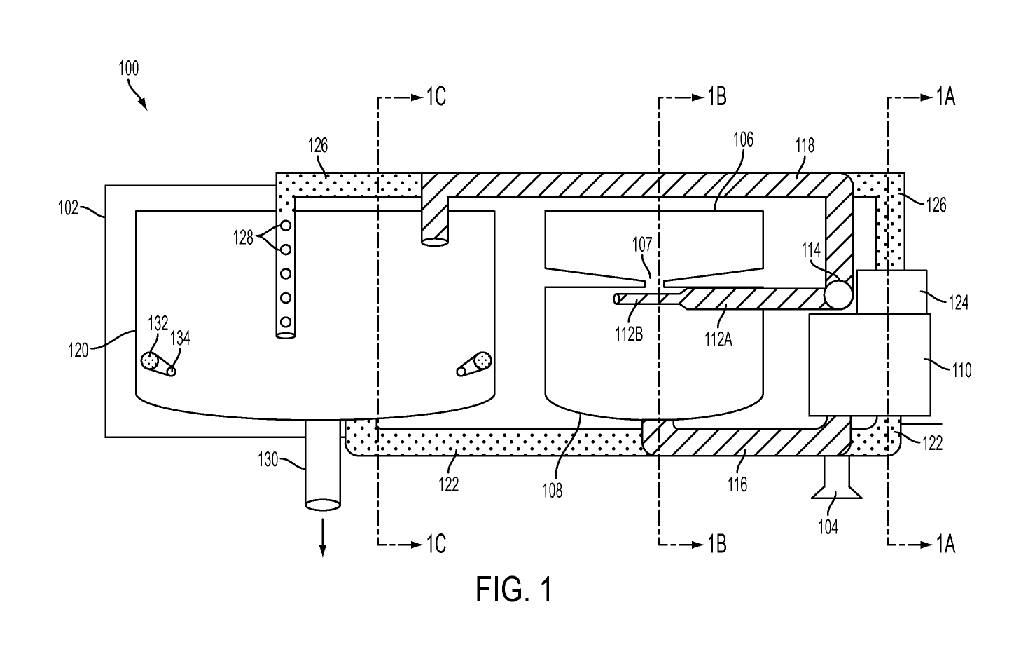

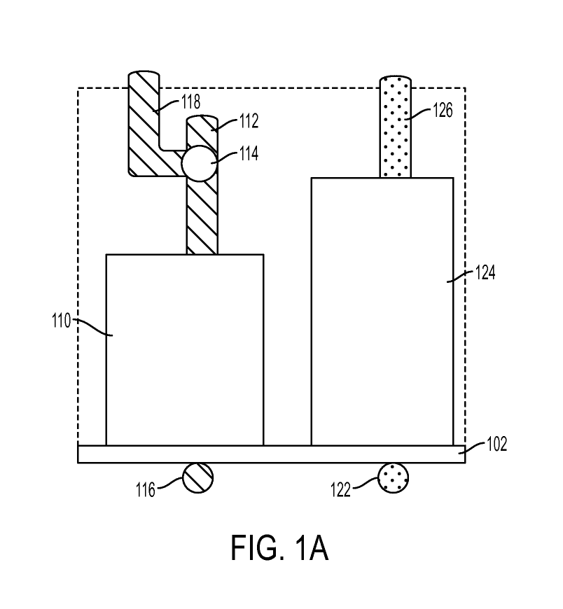

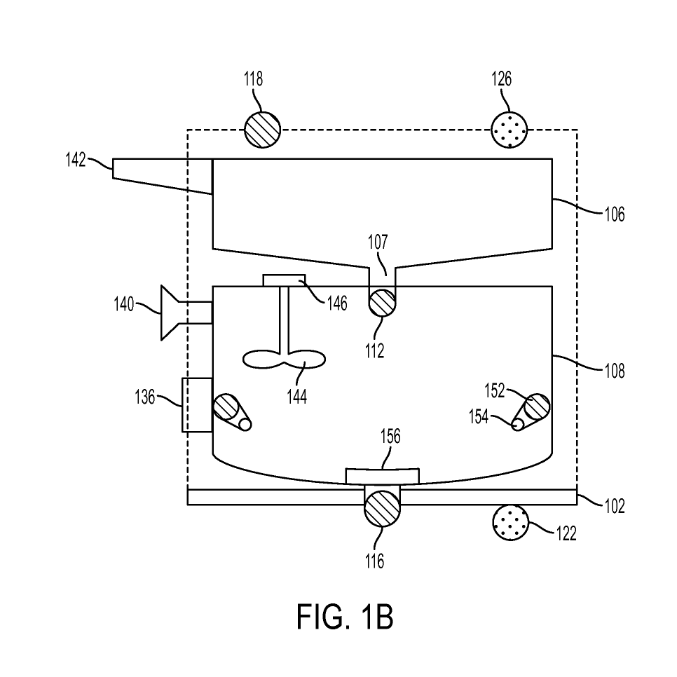

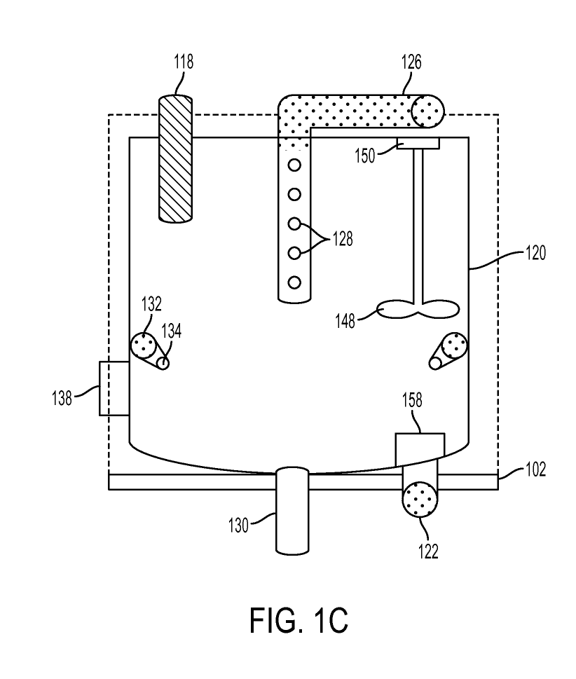

FIG. 1 is a schematic representation of elements of the mobile fracking slurry mixing device 100. The functional structures of the mobile fracking slurry mixing device 100 are mounted on and/or with a transportable framework 102. The transportable framework 102 can be mounted on a flatbed truck trailer, within a flatbed truck container, or a flatbed truck container trailer may be adapted to be dedicated to house the functional components of a mobile fracking slurry mixing device 100. Such embodiments are configured to be transportable on roads, freeways, highways, over bridges, through tunnels, and any other standard thoroughfare without being an obstacle to traffic and without requiring an individually specialized vehicle to transport the framework. In embodiments, the entire mobile fracking slurry mixing device 100 can fit onto and/or within a forty-six foot (46′) box trailer. Embodiments of the transportable framework 102 are not limited to variations relating to flatbed trucks, and may also include transportation frameworks 102 adapted for transport by crane, rail, boat, plane, and/or other vehicles. FIG. 1 further indicates cross-sectional lines which are further illustrated as FIGS. 1A, 1B, and 1C. The cross-sectional schematic representations in FIGS. 1A, 1B, and 1C illustrate (in part) elements of the apparatus in close proximity to each cross-sectional line, in addition to elements directly along each cross-sectional line, in order to more clearly represent the discussed elements. FIG. 1A, for example, is a cross-sectional schematic representation of a portion of the mobile fracking slurry mixing device as illustrated in FIG. 1. In particular, FIG. 1A is an illustration of a portion of the front end of the transportable frame 102, which includes a primary mixing pump 110, a supplementary mixing pump 124, and related piping.

In some embodiments or aspects, the mobile tracking slurry mixing device 100 includes a primary mixing section and a supplementary mixing section. The primary mixing section is where a solid material is initially combined and mixed with a fluid to form a slurry. In embodiments, the solid material is a power, clay, clay-thickened grease, sand, or other proppant material, optionally with additional chemical additives (referred to herein as a “guar powder”), that is combined with a mineral oil fluid which includes surfactants (referred to herein as a “surfactant package”). The combination of the guar powder and the surfactant package forms a tracking slurry. The primary mixing section includes a solid material hopper 106 that is situated above a primary mixing tank 108, with a hopper-tank opening 107 between the solid material hopper 106 and primary mixing tank 108 that is substantively vertically oriented. The guar powder is loaded into and held by the solid material hopper 106, and passes through the hopper-tank opening 107 at least in part due to gravity. A guar powder can be lifted and poured into the solid material hopper 106 by a hydraulic crane, which can lift at least 2,000 pounds of guar powder as held in an industry standard super sack. The solid material hopper 106 can be shaped to have an inclined bottom such that guar powder held in the solid material hopper 106 is directed toward the hopper-tank opening 107. A primary mixing conduit 112 is positioned in a substantively horizontal orientation to the hopper-tank opening 107, such that fluid passing through the primary mixing conduit 112 passes beneath the hopper-tank opening 107. In embodiments, the primary mixing conduit 112 can be a solid four inch (4″) pipe with a one inch (1″) flow moving at a speed which draws guar powder from the solid material hopper 106 into the primary mixing tank 108. In embodiments, the hopper-tank opening 107 is welded to the primary mixing conduit 112 such that the guar powder enters directly into the slurry flow of the primary mixing conduit 112. Further, the primary mixing conduit 112 is configured to have at least two portions, a wide-diameter portion 112A and a narrow-diameter portion 112B.

A primary mixing pump 110 is in fluid communication with the primary mixing conduit 112 and provides a flow of fluid and/or slurry to and through the primary mixing conduit 112, past the hopper-tank opening 107, and into the primary mixing tank 108. As the flow of fluid and/or slurry moves through the wide-diameter portion 112A of the primary mixing conduit 112 to the narrow-diameter portion 112B of the primary mixing conduit 112, the speed of the fluid and/or slurry flow increases in response, (because the velocity of a fluid must increase as the cross sectional area through which it passes decreases). The increase of fluid and/or slurry flow speed results in a Venturi effect where the fluid pressure of the fluid and/or slurry decreases, creating a fluid pipe jet effect from the exit of the primary mixing conduit 112, and particularly from the exit mouth of the narrow-diameter portion 112B of the primary mixing conduit 112. The primary mixing conduit 112 is configured to direct the relatively low-pressure and high speed fluid and/or slurry flow beneath the hopper-tank opening 107, such that the solid material held in the solid material hopper 106 is drawn down by the Venturi effect forces other words, by suction) into the flow of the primary mixing conduit 112 and the primary mixing tank 108. Further, the speed of the fluid and/or slurry flow can create shearing forces that agitate and mix the guar powder with the surfactant package. Thus, in aspects, the primary mixing pump 110 in fluid communication with the primary mixing conduit 112 can function as a mixing agitator system.

In some embodiments or aspects, the primary mixing pump 110 can be a centrifugal pump positioned toward the front end of the transportable framework 102. The primary mixing pump 110 can have a 150-250 horsepower motor, which in embodiments can be a diesel engine. The primary mixing pump 110 is in fluid communication with the primary mixing conduit 112, and particularly in direct fluid communication with the wide-diameter portion 112A of the primary mixing conduit 112. The wide-diameter portion 112A of the primary mixing conduit 112 can have an internal diameter of about four inches (4″), though in embodiments the end of the wide-diameter portion 112A of the primary mixing conduit 112 proximate to the primary mixing pump 110 can have an internal diameter of about six inches (6″) or any other width appropriate to interface with the primary mixing pump 110. As fluid and/or slurry driven by the primary mixing pump 110 moves through the primary mixing conduit 112 toward the primary mixing tank 108, the internal diameter of the primary mixing conduit 112 reduces in size such that the narrow-diameter portion 112B of the primary mixing conduit 112 has an external diameter of four inches (4″) and an internal diameter of about two inches (2″). In further embodiments, either the wide-diameter portion 112A or the narrow-diameter portion 112B of the primary mixing conduit 112 can have one or more changes in diameter as the overall internal diameter of the primary mixing conduit 112 decreases to form a fluid pipe jet effect. In embodiments, the fluid pipe jet effect can provide from about 90 to about 120 pounds of force at the exit mouth of the primary mixing conduit 112. Any embodiment of the primary mixing conduit 112 can be configured and adapted to generate the fluid speed and force of a fluid pipe jet effect. In embodiments, the primary mixing tank 108 can have a rounded bottom surface, which can be convex, concave, or a patterned combination of convex and concave formations, such that slurry held and circulated in the primary mixing tank 108 follows a flow path along the rounded bottom surface which aids in maintaining the slurry in suspension. Further, the rounded bottom surface can be configured to make mixing and stirring of the slurry easier.

In some embodiments or aspects, the primary mixing tank 108 is in fluid communication with a primary mixing outlet 116. In embodiments, the primary mixing outlet 116 is connected to the primary mixing tank 108 at or proximate to the lowest vertical position of the rounded bottom of the primary mixing tank 108. The primary mixing tank 108 is open to the primary mixing outlet 116 such that fracking slurry, and any particulate matter that may fall out of suspension from the fracking slurry, is drawn to the opening of the primary mixing outlet 116 by gravity, the flow of the slurry as it is mixed within the primary mixing tank 116, and/or by the draw of fluid flow generated by the primary mixing pump 110. A primary sump 156 within the primary mixing tank 108 functions to collect and direct fluid into the primary mixing outlet 116. The end of the primary mixing outlet 116 distal from the primary mixing tank. 108 is connected to and in fluid communication with the primary mixing pump 110. Thus, the primary mixing outlet 116 operates as a return pipe, positioned underneath the primary mixing tank 108 and returning fluid and/or slurry back to the primary mixing pump 110 to be recirculated through the primary mixing conduit 112 and back into the primary mixing tank 108. In embodiments, the primary mixing outlet 116 and/or the primary mixing pump 110 are connected to and in fluid communication with a mixing fluid inlet 104. Unmixed surfactant package fluid, or other fluids such as water or mineral oil, can be introduced into the primary mixing section, and the mobile fracking slurry mixing device 100 as a whole, through the mixing fluid inlet 104. In embodiments, the primary mixing pump 110 is adaptable to interface with pipes with diameters from about two inches (2″) to about four inches (4″).

In some embodiments or aspects, the mineral oil is introduced into the primary mixing tank via a flow meter 140 which can regulate the input of mineral oil or other mixing fluid into the primary mixing tank 108. In further embodiments the guar powder can be introduced to the solid material hopper 106 through a loading hopper 142. In embodiments, the loading hopper 142 can hold a five-gallon volume of guar powder or other proppants and introduce guar powder into the solid material hopper 106 as a continuous stream or as incremental batches. The guar powder and mineral oil can be mixed together for about thirty (30) minutes to form a well-mixed fracking slurry. The fracking slurry may be mixed for periods of time appropriate to ensure sufficient mixing between the various guar powder and surfactant package materials that can be used to form a fracking slurry.

FIG. 1B is a cross-sectional schematic representation of a portion of the mobile fracking slurry mixing device as illustrated in FIG. 1. In particular, FIG. 1B is an illustration of a portion of the primary mixing section of the mobile fracking slurry mixing device 100, which includes the primary mixing tank 108, the solid material hopper 106, and related piping. FIG. 1B further illustrates a vertically mounted primary agitator 144 which is driven by a primary agitation motor 146 attached at the top of the primary mixing tank 108. In some aspects, the vertically mounted primary agitator 144 can have a fan connected to a solid pipe or rod which extends into the primary mixing tank 108, where the end of the pipe distal from the fan of the vertically mounted primary agitator 144 is mechanically coupled to the primary hydraulic motor 146 such that the primary agitation motor 146 causes the vertically mounted primary agitator 144 to rotate and accordingly mix fracking slurry held within the primary mixing tank 108. In other aspects, there can be a plurality of vertically mounted primary agitators 144 mounted within the primary mixing tank, driven by at least one primary agitation motor 146. In further aspects, the vertically mounted primary agitator 144 can have a fan with a width of about sixteen inches (16″), a pipe with a diameter of about one inch (1″) and extend into the primary mixing tank 108 to a position about two feet (2′) from the bottom surface of the primary mixing tank 108 and/or to a position above a plane defined by the location of primary mixing jet nozzles 154 mounted to the side walls of the primary mixing tank 108.

FIG. 18 additionally illustrates a primary sampling port 136 located proximate to, and in fluid communication with, the primary mixing tank 108. The primary sampling port 136 is configured to allow sampling of the slurry mixture from the primary mixing tank 108 for on-site and/or laboratory mixing. Once sampled and tested for specific properties, such as hydration of the slurry in view of a time period of mixing, an operator or other control system can determine if and when the fracking slurry is in condition to be transferred to the supplementary mixing tank 120 and/or in condition to be delivered to a well for performing hydraulic fracking.

In further embodiments or aspects, the primary mixing tank 108 is configured to include a primary perimeter mixing conduit 152 which is in fluid communication with the primary mixing inlet 126, the primary mixing conduit 112, and/or the primary mixing outlet 116. The primary perimeter mixing conduit 152 is arranged around the internal wall of the primary mixing tank 108 and includes at least one, and in many embodiments a plurality of, primary mixing jet nozzles 154. The primary mixing jet nozzles 154 are each in fluid communication with the primary perimeter mixing conduit 152 and are positioned to direct fracking slurry flow in a manner that continues to agitate and mix the fracking slurry as it is held and circulated within the primary mixing tank 108. As fracking slurry is circulated through the primary perimeter mixing conduit 152, a portion of the fracking slurry flow will pass into a primary mixing jet nozzle 154. Each primary mixing jet nozzle 154 has an initial internal diameter proximate to the primary perimeter mixing conduit 152, and a relatively narrower internal diameter distal from the primary perimeter mixing conduit 152. Accordingly, the speed of the fracking slurry flow increases as it exits the primary mixing jet nozzle 154, resulting in a fluid pipe jet effect from the exit mouth of each primary mixing jet nozzle 154. In some aspects, the diameter of a primary mixing jet nozzle 154 is three inches (3″) at the end connected to the primary perimeter mixing conduit 152 and narrows to a diameter of one inch (1″) at the exit mouth of the primary mixing jet nozzle 154 where fracking slurry is reintroduced into the primary mixing tank 108. In embodiments, eight (8) primary mixing jet nozzles 154 are positioned around the perimeter of the primary mixing tank 108, and may be staggered in position relative to each other, and may further be grouped into sets of two (2) primary mixing jet nozzles 154 in order to ensure an even mixing flow within the primary mixing tank 108. Other embodiments may use more or fewer primary mixing jet nozzles 154 in other grouping configurations. In further aspects, the primary mixing jet nozzles 154 can be configured to direct the fracking slurry flow in a direction opposite to, orthogonal to, and/or complementary to the mixing and agitation motion and flow generated from vertically mounted primary agitators 144 in the primary mixing tank 108. In aspects, the vertically mounted primary agitators 144 can be fans, propellers, impellers, or other such structures that can physically agitate a fluid or slurry. In yet further aspects, the primary mixing jet nozzles 154 may be configured to direct slurry flow along the contour of the rounded bottom of the primary mixing tank 108, generating shearing forces which further mix the fracking slurry as the fracking slurry sweeps across the interior surface of the primary mixing tank 108.

Once the fracking slurry is adequately mixed to be a stable and suspendable fracking slurry in the primary mixing tank 108, the fracking slurry can be moved to the supplemental mixing tank 120. A transfer valve 114 in fluid communication with the primary mixing pump 110 and/or the primary mixing conduit 112 can be set such that fracking slurry is no longer circulated within the primary mixing section of the mobile fracking slurry mixing device 100, but is directed through the transfer valve 114 into a transfer conduit 118. In aspects, the transfer valve 114 can be any type of valve, and may particularly be a one-way valve (such as a check valve) so as to prevent any backflow of fracking slurry from the transfer conduit 118 back into the primary mixing conduit 112, primary mixing pump 110, or primary mixing tank 108. The transfer conduit 118 is in fluid communication with the supplementary mixing tank 120 and outlets the fracking slurry into the secondary mixing section of the mobile fracking slurry mixing device 100, and specifically into the supplementary mixing tank 120. In some aspects, the transfer conduit 118 can have a six inch (6″) diameter that delivers the fracking slurry with a fluid pipe jet effect into the supplementary mixing tank 120.

FIG. 1C is a cross-sectional schematic representation of a portion of the mobile fracking slurry mixing device as illustrated in FIG. 1. In particular, FIG. 1C is an illustration of a portion of the supplementary mixing section of the mobile fracking slurry mixing device 100, which includes the supplementary mixing tank 120 and related piping. Once the slurry is held within the supplemental mixing tank 120, the components of supplemental mixing section function to maintain the slurry, e.g. keeping the slurry adequately or evenly distributed, keeping the guar powder in suspension in the slurry, keeping the temperature, pH, viscosity, density, hydration, centipoise, suspension distribution and other properties of the slurry within desired parameter ranges. In particular, testing of centipoise and hydration can be performed at intervals to evaluate the ability of fracking slurry to hydrate, and accordingly to determine if the fracking slurry is in condition to be supplied to a hydraulic fracking well. In embodiments, the supplementary mixing tank further includes at least one vertically mounted supplementary agitator 148, such as paddles or fans, driven by at least one supplementary agitation motor 150 located at the top of the supplementary mixing tank 120. In aspects, the vertically mounted supplementary agitators 148 can be fans, propellers, impellers, or other such structures that can physically agitate a fluid or slurry. In further embodiments, the vertically mounted supplementary agitator 148 can have a fan with a width of about sixteen inches (16″), a pipe with a diameter of about one inch (1″) and extend into the supplementary mixing tank 120 to a position about two feet (2′) from the bottom surface of the supplementary mixing tank 120 and/or to a position above a plane defined by the location of supplementary mixing jet nozzles 134 mounted to the side walls of the supplementary mixing tank 120.

In further embodiments or aspects, vertical agitation to mix the fracking slurry in the supplementary mixing tank 120 can be driven by supplementary mixing jet nozzles 134 mounted to the side walls of the supplementary mixing tank 120, configured and positioned to generate a fluid flow such that fracking slurry moves in a circular motion from the bottom to the top of the supplementary mixing tank 120. In embodiments, the supplementary mixing tank 120 can have a rounded bottom surface, which can be convex, concave, or a patterned combination of convex and concave formations, such that slurry held and circulated in the supplementary mixing tank 120 follows a flow path along the rounded bottom surface which aids in maintaining the slurry in suspension. In embodiments, the supplementary mixing tank is in fluid communication with a supplementary mixing outlet 122 at, or proximate to, the lowest vertical position of the rounded bottom of the supplementary mixing tank 120. A supplementary sump 158 within the supplementary mixing tank 120 functions to collect and direct fluid into the supplementary mixing outlet 122. The supplementary mixing tank 120 is connected to the supplementary mixing outlet 122 such that fracking slurry, and any particulate matter that may fall out of suspension from the fracking slurry, is drawn to the supplementary sump 158 and the opening of the supplementary mixing outlet 122 by gravity, the flow of the slurry as it is mixed within the supplementary mixing tank 120, and/or by the draw of fluid flow generated by the supplementary mixing pump 124. The end of the supplementary mixing outlet 122 distal from the supplementary mixing tank 120 is connected to and in fluid communication with the supplementary mixing pump 124. Thus, the supplementary mixing outlet 122 operates as a return pipe, positioned underneath the supplementary mixing tank 120, continuing underneath the primary mixing section, and returning fluid and/or slurry back to the supplementary mixing pump 124 to be recirculated through the supplementary mixing inlet 126 and back into the supplementary mixing tank 120. In embodiments, the supplementary mixing pump 124 is adaptable to interface with pipes with diameters from about four inches (4″) to about six inches (6″). Thus, in aspects, the supplementary mixing pump 124 in fluid communication with the supplementary mixing outlet 122 can function as a mixing agitator system.

In further embodiments or aspects, the end of the supplementary mixing inlet 126 distal from the supplementary mixing pump 124 extends into the volume of the supplementary mixing tank 120 such that, during normal operation, the supplementary mixing inlet 126 is partially submerged in fracking slurry. The end of the supplementary mixing inlet 126 that extends into the volume of the supplementary mixing tank 120 can have shearing openings 128 such that as the flow of fracking slurry, being recirculated into the supplementary mixing tank 120, passes by and through the shearing openings 128, the fluid dynamics (i.e. shearing forces) of the fracking slurry flow proximate to the shearing openings 128 further agitate and mix the fracking slurry as it is held in the supplementary mixing tank 120.

In further embodiments or aspects, the supplementary mixing tank 120 is configured to include a supplementary perimeter mixing conduit 132 which is in fluid communication with the supplementary mixing inlet 126, the supplementary mixing pump 124, and/or the supplementary mixing outlet 122. The supplementary perimeter mixing conduit 132 is arranged around the internal wall of the supplementary mixing tank 120 and includes at least one, and in many embodiments a plurality of, supplementary mixing jet nozzles 134. The supplementary mixing jet nozzles 134 are each in fluid communication with the supplementary perimeter mixing conduit 132 and positioned to direct fracking slurry flow in a manner that continues to agitate and mix the fracking slurry as it is held within the supplementary mixing tank 120. As fracking slurry is circulated through the supplementary perimeter mixing conduit 132, a portion of the fracking slurry flow will pass into a supplementary mixing jet nozzle 134. Each supplementary mixing jet nozzle 134 has an initial internal diameter proximate to the supplementary perimeter mixing conduit 132, and a relatively narrower internal diameter distal from the supplementary perimeter mixing conduit 132. Accordingly, the speed of the fracking slurry flow increases as it exits the supplementary mixing jet nozzle 134, resulting fluid pipe jet effect from the exit mouth of each supplementary mixing jet nozzle 134. In embodiments, the diameter of a supplementary mixing jet nozzle 134 is three inches (3″) at the end connected to the supplementary perimeter mixing conduit 132 and narrows to a diameter of one inch (1″) at the exit mouth of the supplementary mixing jet nozzle 134 where fracking slurry is reintroduced into the supplementary mixing tank 120. In embodiments, sixteen (16) supplementary mixing jet nozzles 134 are positioned around the perimeter of the supplementary mixing tank 120, and may be staggered in position relative to each other, and may further be grouped into sets of four (4) supplementary mixing jet nozzles 134 in order to ensure an even mixing flow within the supplementary mixing tank 120. Other embodiments may use more or fewer supplementary mixing jet nozzles 134 in other grouping configurations. In further embodiments, the supplementary mixing jet nozzles 134 can be configured to direct the fracking slurry flow in a direction opposite to, orthogonal to, and/or complementary to the mixing and agitation motion and flow generated from vertically mounted supplementary agitators 148 in the supplementary mixing tank 120. In yet further embodiments, the supplementary mixing jet nozzles 134 may be configured to direct slurry flow along the contour of the rounded bottom of the supplementary mixing tank 120, generating shearing forces which further mix the fracking slurry as the fracking slurry sweeps across the interior surface of the supplementary mixing tank 120.

FIG. 1C additionally illustrates a supplementary sampling port 138 located proximate to, and in fluid communication with, the supplementary mixing tank 120. The supplementary sampling port 138 is configured to allow sampling of the slurry mixture from the supplementary mixing tank 120 for on-site and/or laboratory mixing. Once sampled and tested for specific properties, an operator or other control system can determine if and when the fracking slurry is in condition to be transferred from the supplementary mixing tank 120 and delivered to a well for performing hydraulic fracking In embodiments, a mixed fracking slurry can be held in a supplementary holding tank 120 and recirculated within a supplementary mixing section for up to several weeks with the fracking slurry retaining the optimal characteristics for use in a hydraulic fracking well.

The supplementary mixing section includes a slurry outlet 130 which is in fluid communication with the supplementary mixing tank 120, through which fracking slurry can be discharged from the mobile fracking slurry mixing device 100. The slurry outlet 130 can interface with a hydraulic fracking well inlet, the slurry outlet 130 having a diameter to match and lock with the hydraulic fracking well inlet, typically via a four inch (4″) camlock. The fracking slurry is drawn from the supplementary mixing tank 120 through the slurry outlet 130 to the hydraulic fracking well inlet (or any other receiving apparatus that can interface with the slurry outlet 130 and drawn out fluid). In embodiments, the slurry outlet 130 is not in direct fluid communication with the supplementary mixing pump 124 or and/or the supplementary mixing outlet 122.

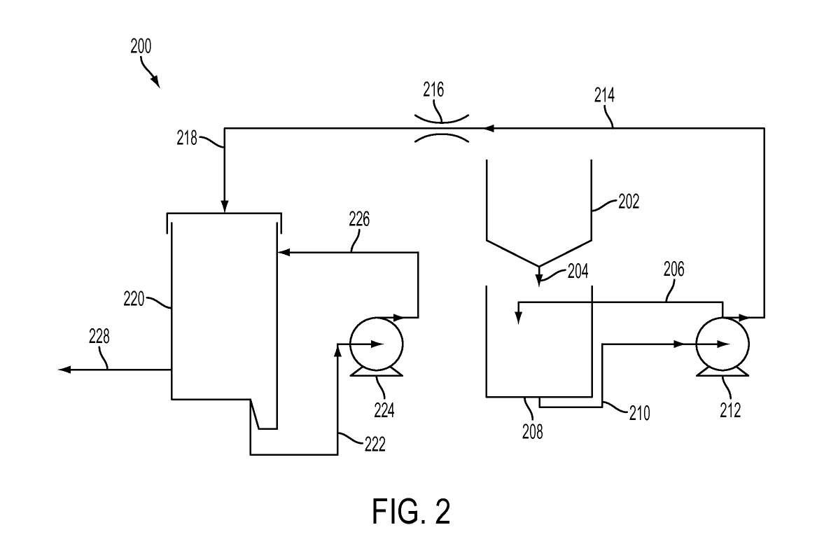

FIG. 2 is a system diagram representing the mobile fracking slurry mixing system 200. A solid material, in particular a proppant or a guar powder for a slurry, is held in a solid material hopper 202. An solid material influx 204 of the solid material is drawn in part by gravity and in part by Venturi force suction from the primary mixing conduit flow 206 into the primary mixing tank 208. The primary mixing tank 208 holds a fluid, in particular a surfactant package, into which the solid material influx 204 enters, mixing the solid material with the fluid within the primary mixing tank, forming a fracking slurry. The primary mixing outlet flow 210, located towards the bottom of the primary mixing tank 208, is driven by the primary mixing pump 212 which draws the fracking slurry from the primary mixing tank 208 through the primary outlet flow 210 into the primary mixing pump 212 and recirculates the fracking slurry into the primary mixing tank 208 through the primary conduit flow 206.

Once an operator or other control system determines that the fracking slurry meets specific requirements, such as being sufficiently mixed, the slurry mixing flow 214 can be directed to and through a transfer valve 216. Once the fracking slurry is through the transfer valve 216, the slurry transfer flow 218 transports the fracking slurry into the supplementary mixing tank 220. In the supplementary mixing tank 220, the fracking slurry continues to be mixed in order to maintain the fracking slurry in suspension as well as its other characteristics, such as temperature, acidity, viscosity, centipoise, and the like. A supplementary outlet flow 222, towards the bottom of the supplementary mixing tank 208, is driven by the supplementary mixing pump 224. The supplementary mixing pump 224 draws the fracking slurry from the supplementary mixing tank 220 through the supplementary outlet flow 222 into the supplementary mixing pump 224 and recirculates the fracking slurry into the supplementary mixing tank 220 through the supplementary mixing inlet flow 226. Once an operator or other control system determines that the fracking slurry is required for use, and confirmed that the fracking slurry remains in condition for use according to desired parameters, the fracking slurry is directed out of the mobile fracking slurry mixing system 200 through the slurry outlet flow 228.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Further, used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified.

The above description is illustrative and is not restrictive, and as it will become apparent to those skilled in the art upon review of the disclosure, that the present invention may be embodied in other specific forms without departing from the essential characteristics thereof. For example, any of the aspects described above may be combined into one or several different configurations, each having a subset of aspects. Further, throughout the foregoing description, for the purposes of explanation, numerous specific details were set forth in order to provide a thorough understanding of the invention. It will be apparent, however, to persons skilled in the art that these embodiments may be practiced without some of these specific details. These other embodiments are intended to be included within the spirit and scope of the present invention. Accordingly, the scope of the invention should, therefore, be determined not with reference to the above description, but instead should be determined with reference to the following and pending claims along with their full scope of legal equivalents.

What is claimed is:

1. A mobile mixing apparatus, comprising:
a transportable framework having a primary mixing section, a transfer conduit, a supplementary mixing section, and an apparatus outlet;
the primary mixing section comprising:
a solid material hopper open to and in communication with a primary mixing conduit, such that solid material held in the solid material hopper can be drawn into the primary mixing conduit;
a primary mixing tank having a concave bottom surface, in fluid communication with the primary mixing conduit;
a primary mixing inlet in fluid communication with the primary mixing tank; and
a primary mixing pump in fluid communication with the primary mixing inlet, the primary mixing tank, and primary mixing conduit, being adapted to mix solid material from the solid material hopper with fluid to form a slurry and circulate the slurry therebetween;
the transfer conduit being in fluid communication with the supplementary mixing section, and adapted to transfer slurry from the primary mixing section to the supplementary mixing section;
the supplementary mixing section comprising:
a supplementary mixing tank having a concave bottom surface, in fluid communication with a supplementary mixing outlet;
a supplementary mixing pump in fluid communication with the supplementary mixing outlet; and
a supplementary mixing inlet in fluid communication with the supplementary mixing pump and supplementary mixing tank, the supplementary mixing pump being adapted to circulate the slurry therebetween; and
the apparatus outlet being in fluid communication with the supplementary mixing tank and adapted to transport slurry out of the supplementary mixing section.

2. The mobile mixing apparatus according to claim 1, wherein the transportable framework can be mounted on a mobile platform.

3. The mobile mixing apparatus according to claim 1, wherein the primary mixing section further comprises a sample port.

4. The mobile mixing apparatus according to claim 1, wherein the primary mixing pump is adapted to mix solid material with fluid by use of shearing forces.

5. The mobile mixing apparatus according to claim 1, wherein the primary mixing inlet is located proximate to the bottom of the concave bottom surface of the primary mixing tank.

6. The mobile mixing apparatus according to claim 1, wherein the primary mixing tank further comprises vertically mounted primary mixing agitators.

7. The mobile mixing apparatus according to claim 1, wherein the supplementary mixing tank further comprises vertically mounted supplementary mixing agitators.

8. The mobile mixing apparatus according to claim 1, wherein the supplementary mixing tank is configured to direct slurry toward the supplementary mixing outlet.

9. The mobile mixing apparatus according to claim 1, wherein the supplementary mixing inlet is configured to generate shear forces as it transports slurry into the supplementary mixing tank.

10. A mobile mixing system, comprising:
a transportable framework having a primary mixing section, and a supplementary mixing section;
the primary mixing section being configured to mix a solid material with a fluid to generate a slurry where the solid material is in suspension in the fluid, and to convey the slurry to the supplementary mixing section; and
the supplementary mixing section being configured to maintain the slurry such that the solid material remains in suspension in the fluid, to store the slurry until required for use, and to deliver the slurry to a location for use.

11. The mobile mixing system according to claim 10, further comprising:
a transfer conduit and an apparatus outlet;
the transfer conduit being in fluid communication with the primary mixing section and the supplementary mixing section, adapted to transfer slurry from the primary mixing section to the supplementary mixing section; and
the apparatus outlet being in fluid communication with the supplementary mixing tank and adapted to transport slurry out of the supplementary mixing section.

12. The mobile mixing apparatus according to claim 10, wherein the transportable framework can be mounted on a mobile platform.

13. The mobile mixing apparatus according to claim 10, wherein the slurry can be mixed or maintained using sheer forces.

14. The mobile mixing apparatus according to claim 10, wherein the slurry can be mixed or maintained using a physical agitator.

15. A method generating and delivering a slurry with a mobile mixing apparatus, the method comprising:
holding a solid material in a solid material hopper;
drawing solid material from the solid material hopper into a primary mixing conduit and combining the solid material with fluid in a primary mixing tank to form a slurry;
mixing the slurry with a primary mixing pump;
conveying the slurry through a transfer valve to a transfer conduit;
conveying the slurry from the transfer conduit into a supplementary mixing tank;
mixing the slurry with a supplementary mixing pump;
maintaining the slurry in suspension in the supplementary mixing tank; and
delivering the slurry from the supplementary mixing tank through an apparatus outlet out attic mobile mixing apparatus.

16. The method according to claim 15, wherein mixing the slurry with a primary mixing pump comprises circulating the slurry between the primary mixing conduit, the primary mixing tank, a primary mixing inlet, and the primary mixing pump.

17. The method according to claim 15, wherein mixing the slurry with a supplementary mixing pump comprises circulating the slurry between the supplementary mixing tank, a supplementary mixing outlet, the supplementary mixing pump and a supplementary mixing inlet.

18. The method according to claim 15, wherein the slurry can be further mixed or maintained using sheer forces.

19. The method according to claim 15, wherein the slurry can be further mixed or maintained using a physical agitator.

20. The method according to claim 15, wherein the mobile mixing apparatus can be mounted to and transported by a mobile platform.
